(19) United States
(12) Patent Application Publication
(10) Pub. No.: US 2010/0154190 A1
(43) Pub. Date: Jun. 24, 2010

(54) METHOD OF MAKING A COMPOSITE DEVICE

(76) Inventor: Kurt M. Sanger, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 12/339,719

(22) Filed: Dec. 19, 2008

(51) Int. Cl. B23P 17/04; B29C 65/48; B23K 1/00

(52) U.S. Cl. 29/428; 156/60; 228/101

(57) ABSTRACT

A method of making a composite device, includes providing a first part including a first set of components at a first pitch; along with providing a second part including a second set of components at a second pitch, different from the first pitch. The first part is fastened to the second part to make a composite device. The composite device includes a subset of the first set of components that are substantially aligned to a subset of the second set of components to form a corresponding subset of substantially aligned composite components.

### FIELD OF THE INVENTION

The present invention relates generally to composite devices that include a first part and a second part that are assembled together, where components of the first part are precisely aligned to corresponding components of the second part.

### BACKGROUND OF THE INVENTION

Early inkjet printheads were made by aligning a nickel nozzle plate to an ejector substrate. Precision alignment of nozzles on the nozzle plate to ejectors on the ejector substrate was critical in order to eject drops in a given direction with good uniformity across multiple nozzles. As inkjet nozzle density and resolution increased, drop on demand inkjet printheads evolved to use Micro Electro Mechanical Systems (MEMS) techniques to directly build nozzles on top of bubble chambers. This has greatly increased the accuracy of the inkjet printhead, and significantly reduced the cost of alignment. For small arrays that print an image on the page by moving back and forth (e.g. in a carriage printer), the increase in cost of the smaller MEMS device has been acceptable. However, to cover a full page width requires tiling many smaller MEMS devices, as the cost of the MEMS device increases exponentially with device size. A further advantage of small arrays moving back and forth to cover the page, is the ability to print each line of the image with multiple nozzles, allowing one to map out bad nozzles and only use working nozzles to print the page. A page width array needs redundant nozzles to eliminate white space errors due to non-working nozzles. What is needed is a manufacturing technique that significantly lowers the cost per nozzle to provide a page wide array with redundant nozzles and accuracy across the whole page.

Additionally, there is a need to create large composite devices with acceptable yield consisting of corresponding components on two different parts that should preferably be aligned together with tight tolerances. There is a need to be able to use inexpensive manufacturing means such as roll-to-roll and tape manufacturing to produce inexpensive parts. However, these inexpensive manufacturing means usually have looser tolerances than are required in the completed composite device. There is a need to combine inexpensive fluidic and optical components made from plastics, tapes, and other inexpensive materials with electronic devices formed on a silicon substrate. There is a need to hold tight tolerances to build electronic devices on substrates other than silicon such as stainless steel and paper.

Furthermore, on devices made with multiple parts, there is a need to hold tolerances between the corresponding components on these parts as the devices heat up and differentially expand.

### SUMMARY OF THE INVENTION

The aforementioned need is met, according to the present invention, by a method of making a composite device that discloses providing a first part including a first set of components at a first pitch; along with providing a second part including a second set of components at a second pitch, different from the first pitch. The first part is fastened to the second part to make a composite device. The composite device includes a subset of the first set of components that are substantially aligned to a subset of the second set of components to form a corresponding subset of substantially aligned composite components.

### BRIEF DESCRIPTION OF THE DRAWINGS

FIG. 1 is a first part with a set of first components at a first pitch;

FIG. 2a is a component consisting of resistors and conductors;

FIG. 2b is a second part with a set of second components at a second pitch;

FIG. 3a illustrates one embodiment of a composite device including two parts containing sets of components at different pitches that are assembled together;

FIG. 3b illustrates one embodiment of a composite device including two parts containing sets of components at different pitches that are assembled together;

FIG. 4 is a first part including an array of subparts, each first subpart having a set of first components at a first pitch;

FIG. 5 is a second part including an array of subparts, each second subpart having a set of second components at a second pitch;

FIG. 6 illustrates one embodiment of a composite device including two parts fastened together, each part including an array of subparts containing sets of components at different pitches;

FIG. 7 is a first part with a set of first components at a first pitch in a first direction and a third pitch in a second direction;

FIG. 8 is a second part with a set of second components at a second pitch in a first direction and a fourth pitch in a second direction;

FIG. 9 illustrates one embodiment of a composite device including two parts containing sets of components at different pitches in two directions that are assembled together;

FIG. 10 illustrates one embodiment of a composite device including two parts containing sets of components at different pitches in two directions that are assembled together at an angle;

FIG. 11 is a part including an array of first subparts, each first subpart having a set of first components at a first pitch in a first direction and a third pitch in a second direction;

FIG. 12 is a part including an array of second subparts, each second subpart having a set of second components at a second pitch in a first direction and a fourth pitch in a second direction;

FIG. 13 illustrates one embodiment of a composite device including two parts fastened together with each part including arrays of subparts containing sets of components at different pitches in two directions;

FIG. 14 illustrates one embodiment of a composite device including two parts fastened together at an angle with each part including arrays of subparts containing sets of components at different pitches in two directions;

FIG. 15 is a prior art surface emitting laser diode consisting of a grating and electrode to be used as a first component in the present invention;

FIG. 16 is a first part consisting of a set of surface emitting laser diode components at a first pitch;

FIG. 17 is a second part consisting of a set of lens components at a second pitch;

FIG. 18 is a prior art lens consisting of a surface features to be used as a second component in the present invention;

FIG. 19 illustrates one embodiment of a first part containing sets of surface emitting laser diode components at a first pitch assembled to a second part consisting of a set of lens components at a second pitch;

FIG. 20 is a first part consisting of first alignment features, a first registration feature, and a set of laser diode components at a first pitch in a first direction and a third pitch in a second direction;

FIG. 21 is a second part consisting of second alignment features, a second registration feature, and a set of lens components at a second pitch in a first direction and a fourth pitch in a second direction;

FIG. 22 illustrates one embodiment of a second part containing a set of lens components aligned to a first part containing a set of laser diode components using second alignment features on second part to locate to first alignment features on first part;

FIG. 23 illustrates one embodiment of a second part containing a set of lens components aligned to a first part containing a set of laser diode components by aligning second registration feature on second part to a first registration feature on a first part;

FIG. 24 is a first part consisting of a set of compound components where each compound component consists of a surface emitting laser diode and an electrical trace at a first pitch;

FIG. 25 is a second part consisting of a set of compound components where each compound component consists of a lens and an electrical trace at a second pitch;

FIG. 26 illustrates one embodiment of a first part containing sets of compound components at a first pitch assembled to a second part consisting of a set of compound components at a second pitch;

FIG. 27 is a second part consisting of a set of compound components where each compound component consists of a lens and one of multiple electrical traces at a second pitch;

FIG. 28 illustrates one embodiment of a first part containing sets of compound components at a first pitch assembled to a second part consisting of a set of compound components at a second pitch with unique electrical connections;

FIG. 29 is an illustration of a source conductor of a transistor component;

FIG. 30 is an illustration of a drain conductor of a transistor component;

FIG. 31 is an illustration of a doped area of a transistor component;

FIG. 32 is an illustration of a gate conductor of a transistor component;

FIG. 33 is an illustration of a transistor composed of source, drain, doped area, and gate, components;

FIG. 34 is an illustration of a first part composed of transistor gate components at a first pitch;

FIG. 35 is an illustration of a second part composed of sets of transistor source and drain components at a second pitch;

FIG. 36 is an illustration of a third part composed of transistor doped regions; and

FIG. 37 is an embodiment of the invention consisting of a first part having a set of components at a first pitch assembled to a second part having a set of components at a second pitch using photo lithography on a single substrate.

### DETAILED DESCRIPTION OF THE INVENTION

In general, in fastening two parts together to make a composite device there is a preferred alignment between the two parts. In some cases, there is a most preferred alignment and a least preferred alignment, along with an acceptable range of alignments. For the preferred alignment the operation of the composite device is significantly improved. For the acceptable range of alignment, the operation is satisfactory. Finally, for the least preferred alignment, the operation is not satisfactory. More specifically, an industry's well-known criteria will govern whether or not the alignment yields a most preferred result. Therefore, each type of composite device will have its own criteria for acceptability.

A method is disclosed for assembling a composite device, including fastening two parts together wherein each part contains a set of components at a given pitch, and the pitches between the components on the two parts are dissimilar. Then, choosing a subset of the composite components such that the tolerance between the composite components in this subset is within acceptable limits or produces acceptable results. It is an advantage of the present invention that every composite device includes a subset that is within acceptable limits and produces acceptable results. Therefore, one can refrain from wasting multiple assembled parts and be confident that there will be a robust and redundant method of manufacturing a composite device.

The present invention can be repeated in an array sense, such that an array of chosen subsets of composite components are within acceptable tolerances or produce acceptable results.

The present invention can provide for multiple subsets of composite components that provide acceptable results thereby providing redundancy and increasing the device yield. The present invention provides for multiple subsets of composite components that provide acceptable results in an array sense thereby providing redundancy across the array and increasing the array device yield.

The present invention can be used to assemble optic components to light emitting components, electrical connections between two components, inkjet nozzle components to ejector device components, and fluidic connections between two components. One disclosed embodiment can make an electrical connection and optical connection or electrical connection and fluidic connection at the same time wherein the electrical connection corresponds to the optimum optical or fluidic connection. The present invention can make multiple connection types at the same time wherein the connected subsets are correlated to each other.

The present invention allows for using a lesser tolerance capable manufacturing method to be combined with a second part resulting in a subset of composite components to fall within acceptable limits or produce acceptable results. These manufacturing methods can include plastic molding using lithographic electroplating molding (LIGA) techniques to build a mold for either hot stamping or ejection molding of plastic or polymer components. Manufacturing methods can also include flexographic, gravure, offset lithography, or electrophotographic printing on a substrate. Substrates can include plastic sheets, paper, metals, metal foils, card stock and cardboard. Ink can consist of colorants, polymers, conductive ink, semiconductive ink, resistive ink, and nonconducting ink. In addition ink can contain dopant materials, or index matching materials.

The present invention assembles two parts together each having a multitude of components arranged in a systematic way such that a subset of the composite components results in acceptable performance. The invention uses additional components that normally are inoperable in order to use reduced manufacturing tolerance parts to produce high tolerance combinations of the two parts.

The present invention anticipates using a single set of composite components within the composite device. The present invention anticipates using more than one set of composite components within the composite device. The present invention anticipates using all of the composite components within the composite device.

An embodiment of the present invention is an inkjet printhead. In this embodiment additional composite components can be used for redundancy to increase the yield or robustness of the printhead. In this embodiment additional composite components can be alternately used while printing to mask drop placement errors.

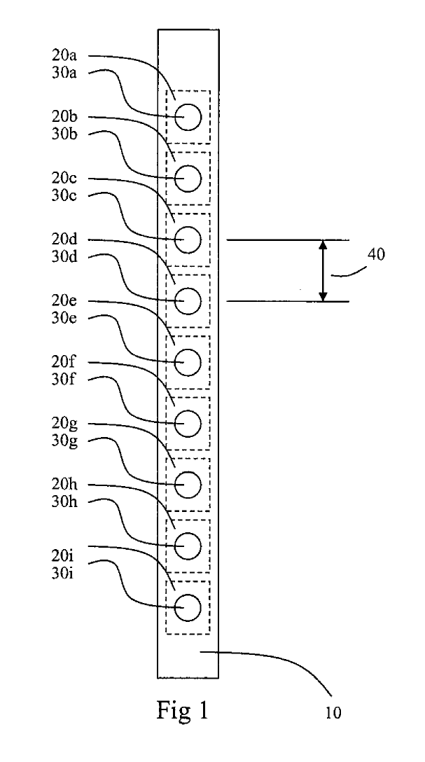

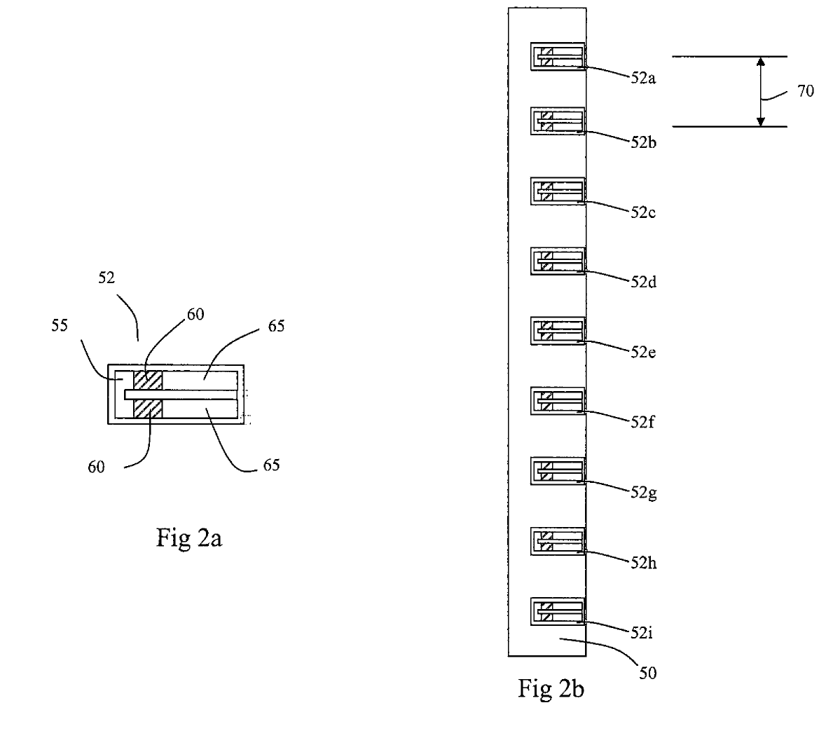

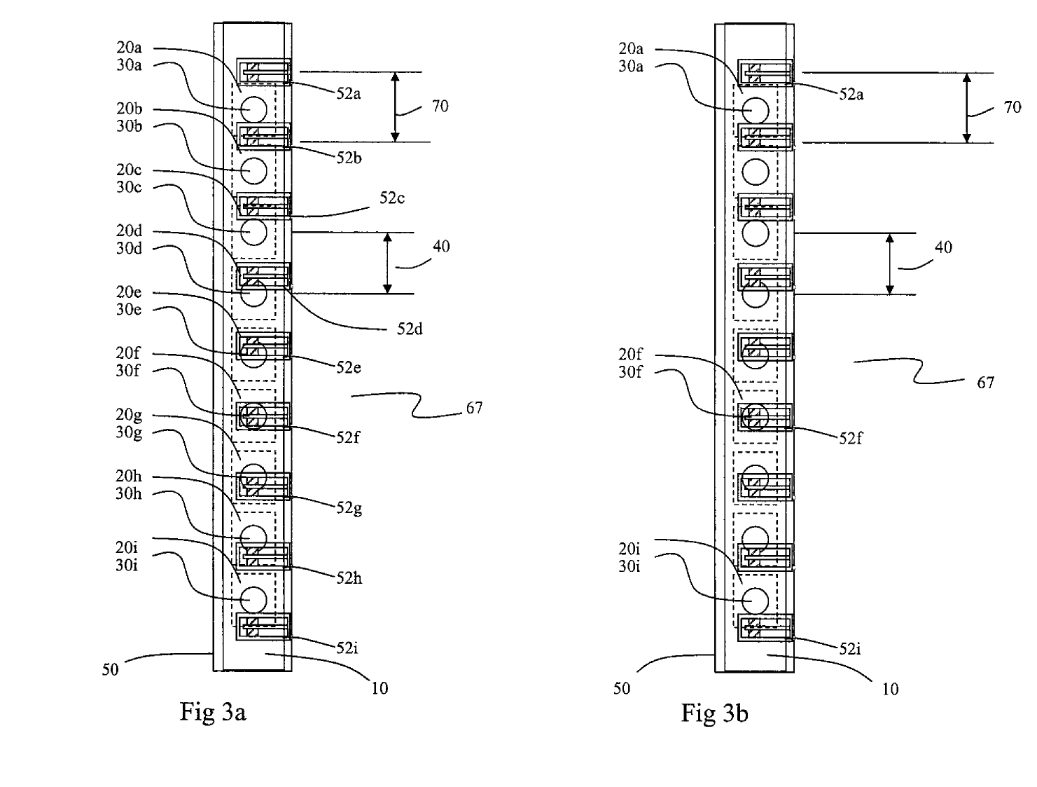

FIG. 1 shows a first part (10) for a thermal inkjet printhead, with a set of first components including bubble chamber components (20a-i) and orifice components (30a-i) at a first pitch (40). FIG. 2a shows a resistor element component (52) consisting of resistor areas (60) preassembled to conductive traces (65) and (55). FIG. 2b shows a second part (50) for the thermal inkjet printhead, with a set of resistor element components (52a-i) at a second pitch (70) different from the first pitch (40). Note that each resistor element component (52a-i) consists of resistor components (65) and electrical trace components (60 and 55) as shown in FIG. 2a. FIG. 3a shows a composite device (67) (i.e. the assembled thermal inkjet printhead) composed of the first part (10) fastened to the second part (50) where first bubble chamber component (20f) and orifice component (30f) are substantially aligned with second resistor element component (52f). FIG. 3b is identical to FIG. 3a with a few of the part numbers removed for clarity. Said first (10) and said second (50) parts can be fastened together, for example, with glue, epoxy, ultra violet cured epoxy, or solder. Alternatively, first and second devices can be welded, or ultrasonically welded together. Additional components can be located on each device to align them to a first tolerance. First and second devices can be held together with screws, nuts and bolts, or rivets. First and second parts can be designed to snap together.

First part (10) can be molded out of plastic using a hot stamp mold. The mold can be made using photolithography to pattern a polymer such as SU-8. Then deposit a layer of Nickel. Then electroplate the Nickel thickness to create the mold. Variations in spacing (first pitch) (40) can occur as the mold heats up, a change in room temperature, or the composition of the part changes. Alternatively, the first part (10) can be formed using an SU-8 tape. Alternatively, the first part (10) can be pressed out of a metal or metal foil. In some embodiments, the orifice component and bubble chamber component can be separate components and both need not be present on the first part (10) in the present invention. An orifice may also be called a nozzle or opening.

The set of resistor element components (52) on the second part (50) can include a components composed of TaSiN resistor component (65) material deposited onto a SiO₂ layer on a Silicon wafer. Conductive trace components (60, 55) can be created using Vapor Deposition of Aluminum. Common photo lithographic techniques and materials can be used to pattern the device (50). Photo lithographic techniques using a Canon 5× Stepper can be accurate to within 0.5 um or less. Alternately the Canon 5× Stepper may be used in a faster 1× mode with lesser accuracy tolerances. Alternatively, the second part (50) can be printed using a silver ink for conductive traces and a carbon ink for the resistor. The substrate can be a plastic, a plastic film, paper, wood, glass, a metal, or a metal foil. The substrate can be individual pieces such as cut sheets of paper or individual wafers. The substrate can be web material such as rolls of paper or stainless steel. The second pitch (70) between resistor components is well defined. However the second pitch (70) can change during operation as the resistors heat up causing the second part (50) to expand. The second pitch (70) can vary for consecutive second parts (50) as the ambient temperature during lithographic exposure varies, or the wafer temperature varies, or the alignment of the mask to the wafer and the dicing operation changes, particularly for large second parts (50) made of materials, such as plastic, having a relatively large coefficient of thermal expansion.

The first pitch (40) is also well defined, though it too may change part to part within a batch or run, batch to batch, or as the part heats up through internal heating or due to external ambient heat.

For web material printing, both pitches can change as the web speeds varies. In addition the placement of a first printed part relative to a second printed part can change as the web speed varies, the web material stretches, or the web material absorbs water or solvent.

One preferable embodiment of the invention is a particular resistor element component is chosen as a most preferred aligned resistor element component/bubble chamber orifice combination. As shown in FIG. 3 resistor element component 52f appears to be preferably aligned. An embodiment of the invention includes choosing a larger subset of combined components corresponding to resistor element components 52e, 52f, and 52g, and then print an image alternately using these three resistors. One skilled in the art will recognize that the number of acceptable combinations of components can be increased by decreasing the differences in the first and second pitch.

One skilled in the art will recognize that the resistor element component is a drop forming mechanism and that other drop forming mechanisms can be used such as a piezoelectric transducer, a resistor driven paddle, and a piezoelectric transducer driven paddle.

For an inkjet printer, the alignment between the resistor and the orifice on the bubble chamber controls the direction of the inkjet drop. One can purposely choose a combination of components that provides the best looking print, instead of choosing the alignment that appears to be best physically aligned. Further one can choose misaligned components to purposely direct inkjet drops in a random way to hide the raster of an inkjet print.

For a manufacturing process that combines a first part (10) with a second part (50) it is possible for a contaminant to block an orifice component (30) making a combined device unusable. In such a case, selection of the next best aligned combination of components occurs. In this example, if orifice 30f were blocked or plugged, one selects orifice 30e or 30g by energizing resistor element components 52e or 52g respectively in order to eject a drop of ink from this set of orifices.

As the composite device (67) ages, or the second part (50) heats up due to operation of resistor components (60) the so-called best aligned components can change. In an exemplary embodiment external detection of changed components is done by examining the alignment of resistor element components (52) to orifice components (30) or by printing a test pattern and evaluating the test pattern for the best combination of orifices to resistors. Subsequently, one can measure the temperature of the first or second part and adjust the chosen components based upon the temperature readings and optionally a first chosen subset.

In the thermal inkjet printhead example described above with reference to FIGS. 1 through 3, the difference between first pitch (40) and second pitch (70) is shown as being large in order to clearly show the effect of mating parts having components at two different pitches. Noting in FIG. 3a that the bottom edge of orifice component (30a) touches the top edge of component (52b), in the same way that the bottom edge of orifice component (30i) touches the top edge of component (52i), it is readily apparent that pitch (40) is seven-eighths of pitch (70), that is, eight times pitch (40) is the same distance as seven times pitch (70). As a result of such a large difference in pitches (40 and 70), the resistor element portion (65) of components (52) fairly quickly become grossly misaligned relative to an orifice component (30) the further away the components are from best aligned pair (30f) and (52f). If, for example, the components (52) were fabricated at a pitch (70) of about 21 microns, corresponding to 1200 per inch, then the example shown in FIG. 3a would be consistent with an orifice component pitch (40) of about 18.4 microns. The difference between pitch (40) and pitch (70) would then be about 2.6 microns, so that if the best aligned pair (32f) and (52f) is perfectly aligned, neighboring component pairs e and g would be misaligned by 2.6 microns in opposite directions. At such amounts of misalignment, printed dot placement on the paper would be significantly different for pairs e, f, and g, and would probably be unacceptable for all other pairs shown in FIG. 3a. Thus, out of the nine component pairs in the composite device shown in FIG. 3a, it is likely that only one third of them might be usable. In some embodiments, a smaller difference between pitches (40) and (70) would be used and/or fewer than nine elements in the sets of first components (20, 30) and second components (52) in order to provide a higher proportion of usable pairs in the composite device (67).

In general, design considerations for choosing how many elements to include in the sets of components, and how much different the pitches should be depend on factors including the following: 1) the tolerance of making the components at a given pitch; 2) the tolerance in alignment of the first part to the second part; 3) the required alignment of a pair of components in order to provide a properly operating composite pair; 4) the desirability of providing redundant operational composite pairs on the composite device; 5) changes in dimensions that can occur due to manufacturing or operational temperature environments, for example; 6) manufacturing cost per component for both the first part and the second part; and 7) space constraints for the composite device.

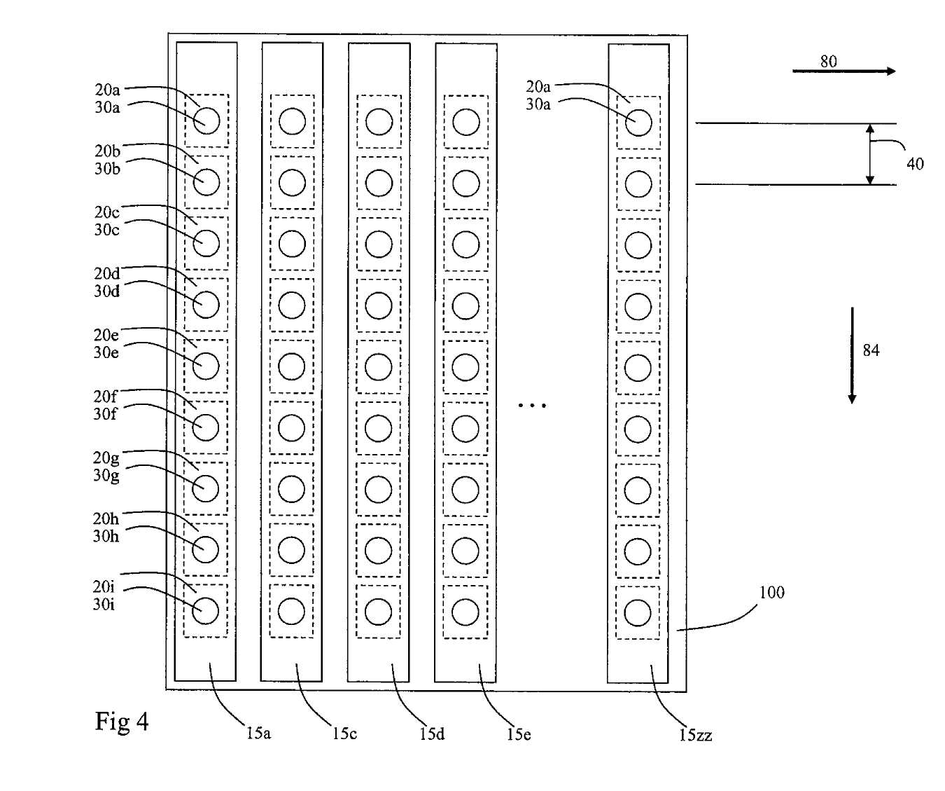

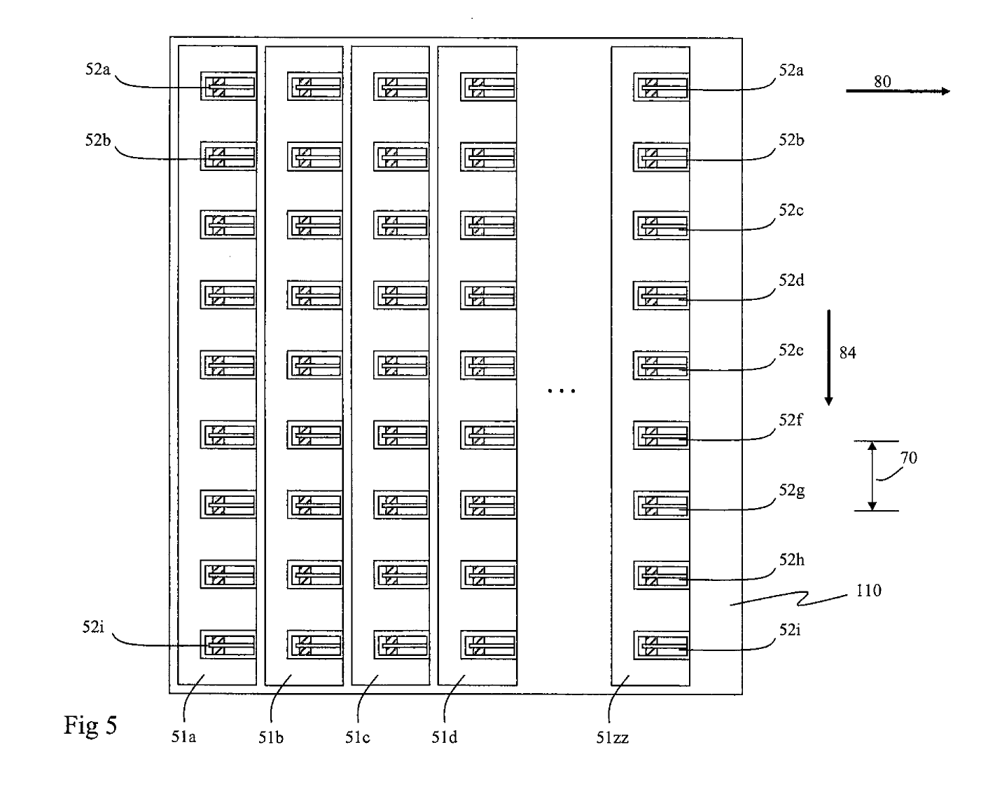

FIG. 4 shows a first part (100) consisting of a first array of subparts (15a-zz) in a direction (80) with first components (20a-i and 30a-i) at a first pitch (40) in a second direction (84) where first components include bubble chamber components (20a-i) and orifice components (30a-i). FIG. 5 shows a second part (110) including of a second array of second subparts (51a-zz) in the same direction (80) with a second set of resistor element components (52a-i) at a second pitch (70), in a second direction (84) different from the first pitch (40).

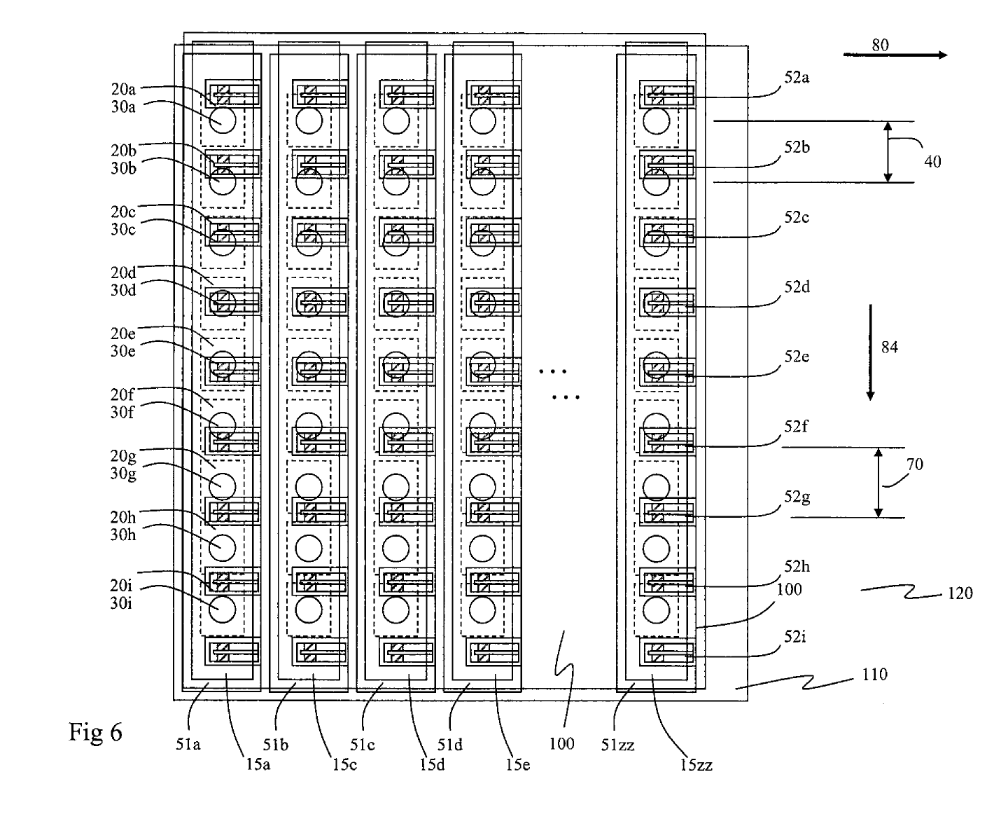

Each resistor element component (52a-i) includes TaSiN resistor components (65) and Al electrical trace components (60 and 55) as shown in FIG. 2a. FIG. 6 shows the composite array device (120) formed by fastening the first part (100) including of the array of first subparts (10a-zz) with the second part (110) including of the array of second subparts (51a-zz) forming an array of subsets of substantially aligned composite components. The array of substantially aligned composite components is aligned to a tolerance. This is shown as first subparts (15a-zz) with first components (20a-i, and 30a-i) combined with second subparts (51a-zz) with second set of components (52a-i) where subset of first components (20d and 30d of 15a-zz) are substantially aligned with subset of second components (52d of 51a-zz), so that the array of subsets of substantially aligned composite components are those in row d of FIG. 6.

One skilled in the art will recognize that the aligned components need not be the same between first subparts (15a-zz) and second subparts (51a-zz). For instance, while the example shown in FIG. 6 shows all columns (a to zz) of the composite array device have one pair alignment in row d (i.e. orifice component 55d aligned to resistor element component 52d), in other examples it is possible that for one or more columns of the subparts (15a-zz, 51a-zz) a different resistor element component and orifice component combination is another aligned combination.

The first part (100) with array of first subparts (15a-zz) can be molded, stamped, printed, etched using photolithography, mechanically assembled, or machined. The second part (110) with array of second subparts (51a-zz) can be manufactured using complementary metal oxide semiconductor (CMOS) technology or MEMs. The two parts can be glued, epoxied, welded, ultrasonically welded, screwed, bolted, or otherwise held or affixed together. A best aligned set of components for each subpart can be chosen within the composite array device. A set can be chosen having as few as one pair of components for each pair of subparts within the composite device. Alternatively, a next best aligned pair of components can be chosen, if it is detected that a particular pair is in nonworking order or produces unacceptable results. Alternatively, a larger subset of best aligned pair of components can be chosen and used.

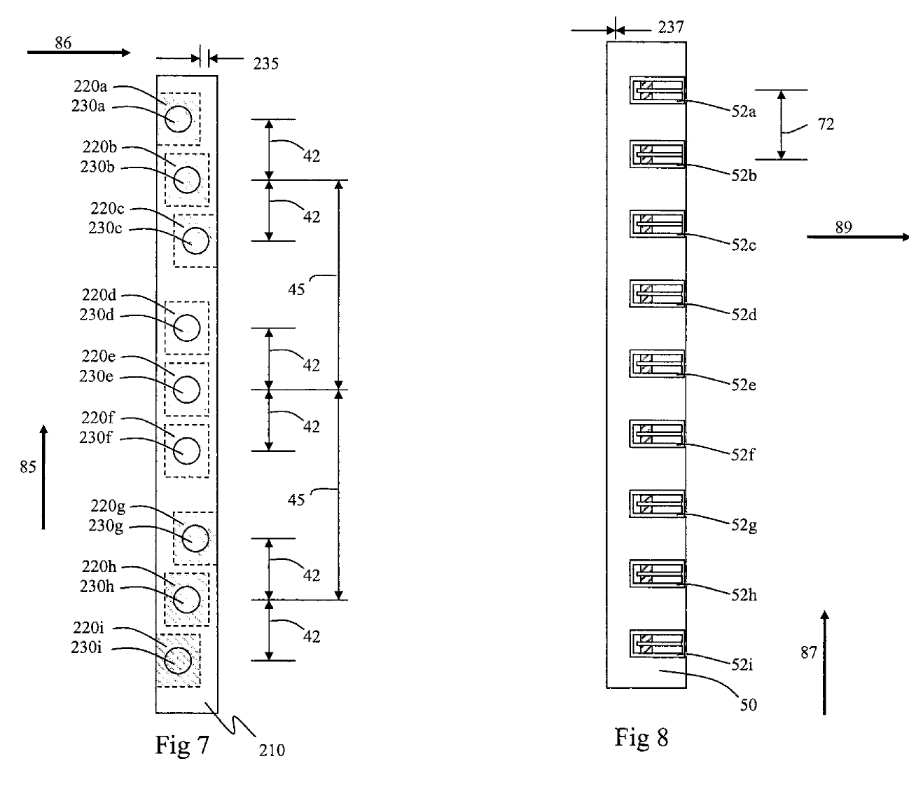

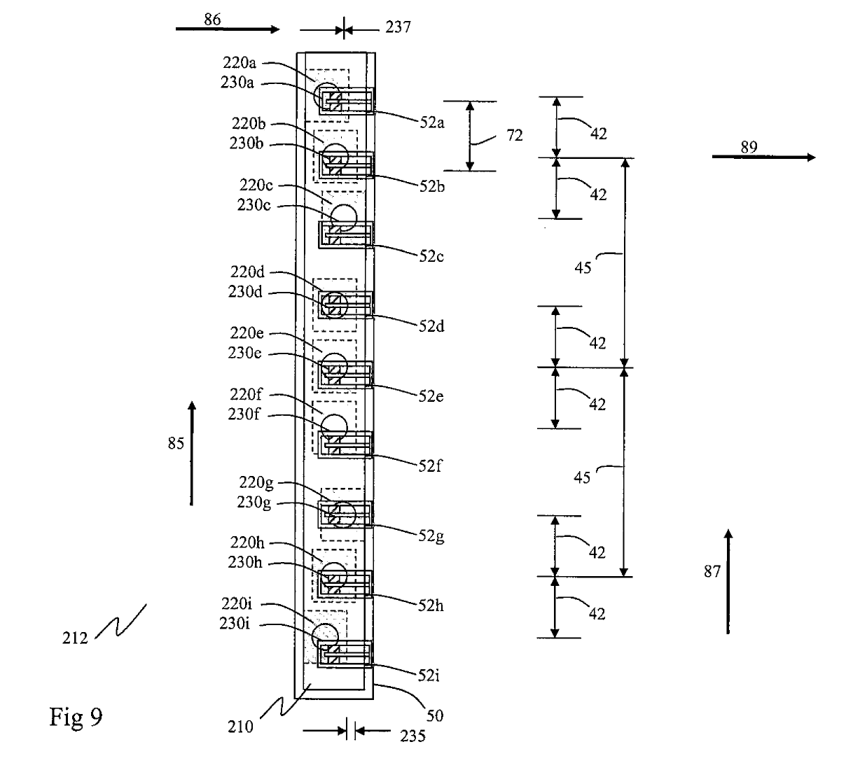

FIG. 7 shows a first part (210) with first components (220a-i and 230a-i) at a first pitch (42) in a first direction (85) and a varying third pitch (235) in a second direction (86). In addition multiple groups of first components (220a-c, 230a-c), (220d-f, 230d-f), and (220g-i, 230g-i) are offset by a multiple (45) of a first pitch (42). FIG. 8 shows a second part (50) with a set of second resistor element components (52a-i) at a second pitch (72) in a first direction (87) different from the first pitch (42) and fourth pitch (237) in a second direction (89) different from the third pitch (235). Note, in the example of FIG. 8, the fourth pitch (237) is equal to zero. FIG. 9 shows a composite device (212) composed of the first part (210) fixed to the second part (50) creating a subset of said first components (220a-i, 230a-i) on said first part (210) aligned with said second components (52a-i) on said second part (50). FIG. 9 shows components (52d, 220d and 230d) as having an alignment in both directions (85 and 86) in composite device (212). In this example first directions 85 and 87, and second directions 86 and 89 are substantially the same respectively.

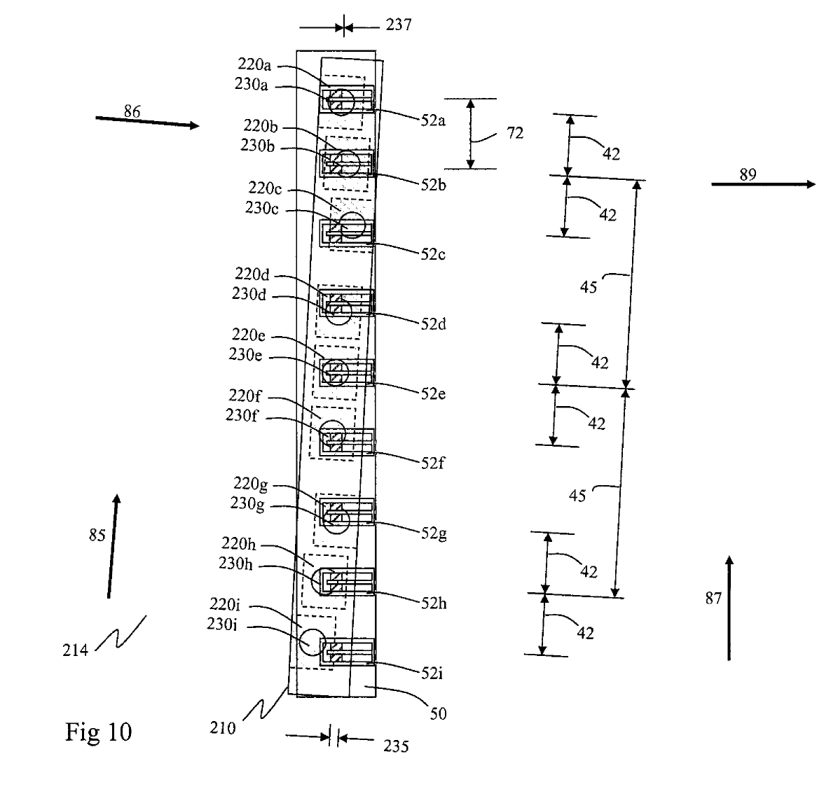

FIG. 10 shows a composite device (214) composed of the first part (210) rotated and fixed to a second part (50) resulting in subset of said first components (220a-i, 230a-i) on said first part (210) aligned with said second components (52a-i) on said second part (50) resulting in 52e, 220e and 230e as having the best alignment. In this example, first directions 85 and 87, and second directions 86 and 89 are rotated slightly relative to each other respectively.

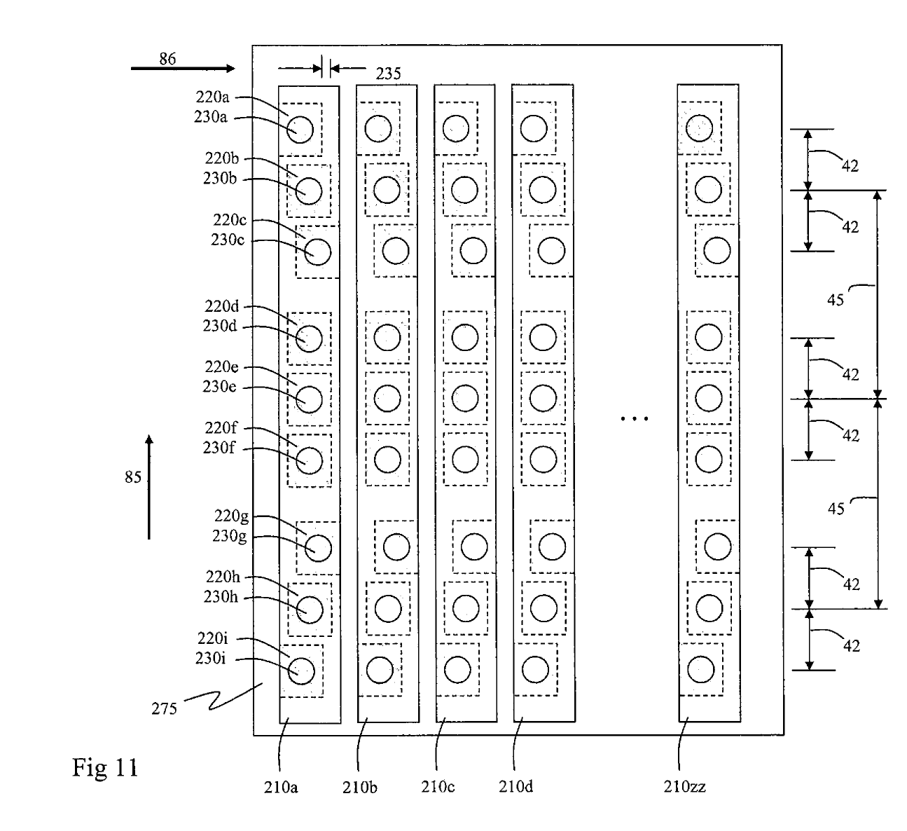

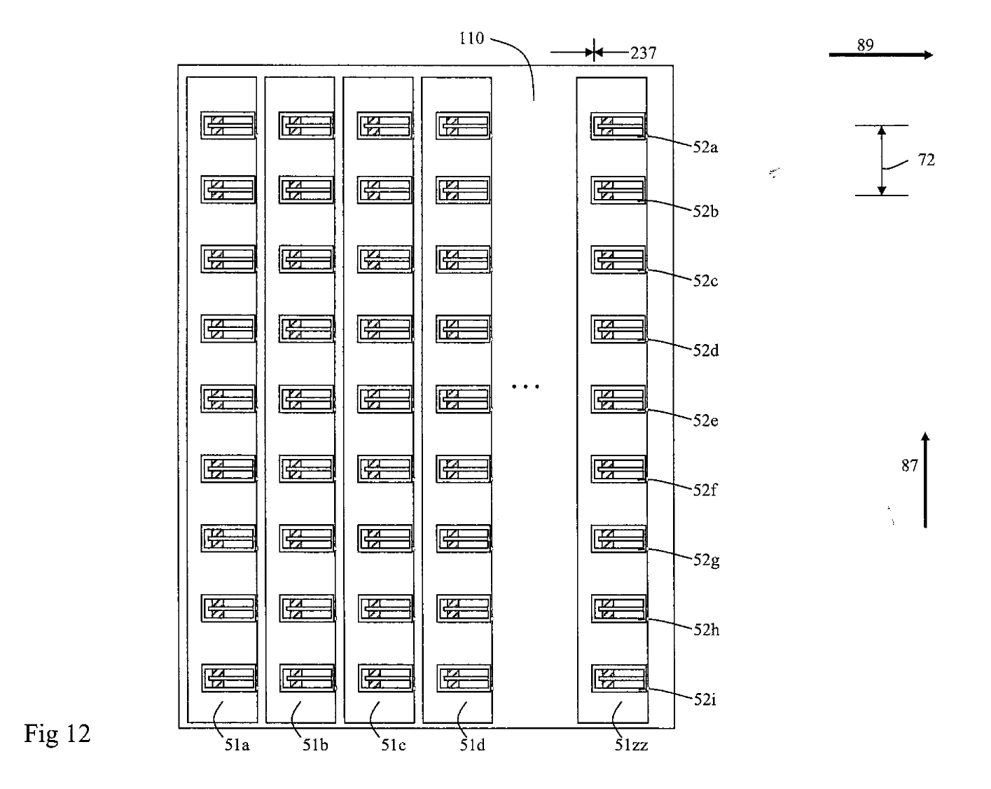

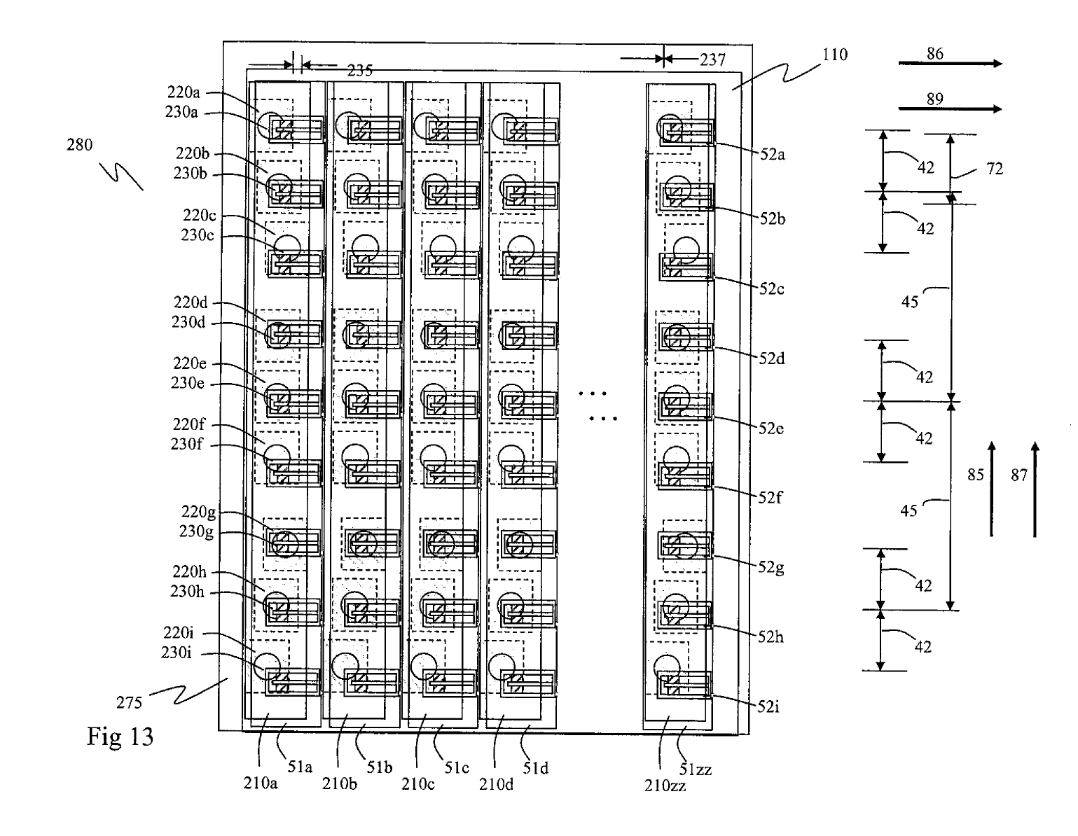

FIG. 11 shows a first part (275) including an array of first subparts (210a-zz) with first components (220a-i and 230a-i) at a first pitch (42) in a first direction (85) and a third pitch (235) in a second direction (86). In addition multiple groups of first components (220a-c, 230a-c), (220d-f, 230d-f), and (220g-i, 230g-i) are offset a multiple (45) of a first pitch (42). FIG. 12 shows a second part (110) including an array of second subparts (51a-zz) with a set of second components (52a-i) at a second pitch (72) in a first direction (87) different from the first pitch (42) and a fourth pitch (237) in a second direction (89), different from the third pitch (235). Note in the example of FIG. 12 the fourth pitch (237) is equal to zero. FIG. 13 shows a composite array device (280) including of the first part (275) fastened to the second part (110) to create the composite array device (280) with a subset of first components (220a-i, 230a-i) on the first array of subparts (210a-zz) aligned with a subset of second components (52a-i) on the second array of second subparts (50a-zz), creating subsets of substantially aligned composite components. In the example shown in FIG. 13, the subset of substantially aligned composite components are in row d of the composite array device (280). First directions 85 and 87 and second directions 86 and 89 are substantially the same respectively.

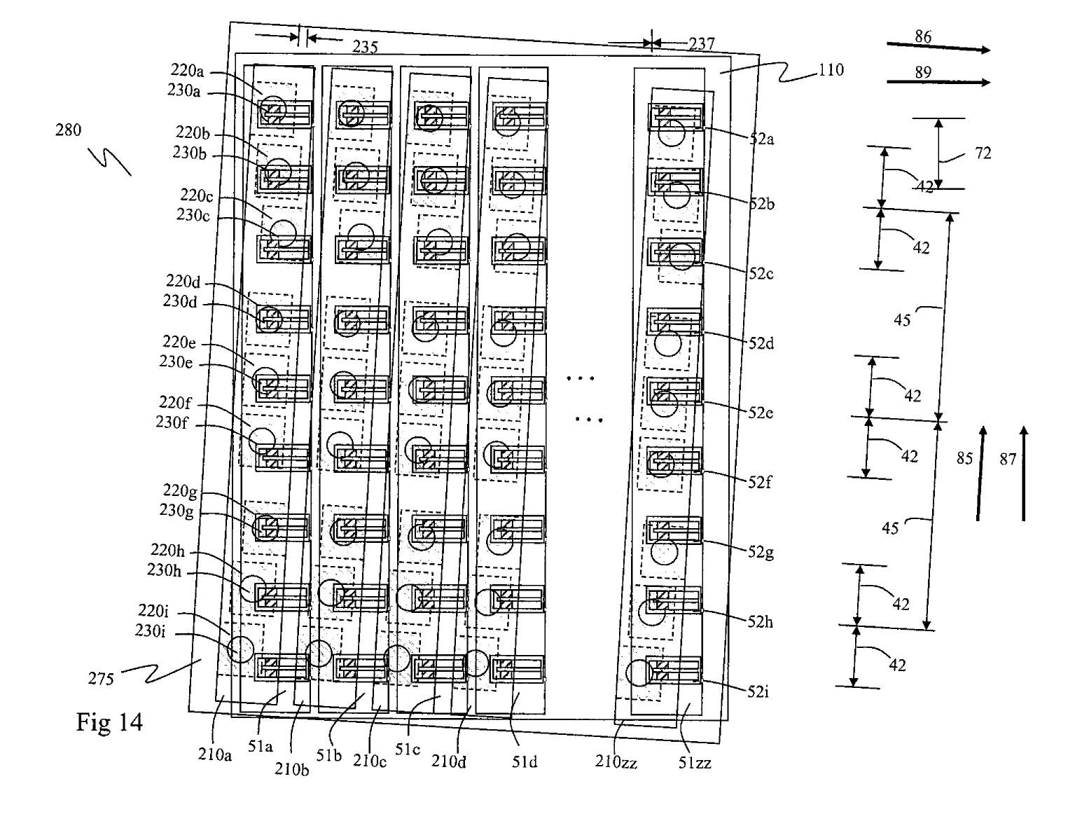

FIG. 14 shows a composite array device 280 where the first part (275) of FIG. 11 is fastened to the second part (110) of FIG. 12 and the first part (275) is rotated and shifted relative to the second part (110). The subset of substantially aligned composite components of resistor element components (52a-i), substantially aligned to second components (220a-i and 230a-i) across the subparts (51a-zz, 210a-zz) changes across the combined array device (280). For instance, in one example subparts 50a and 210a have components 220g, 320g, and 52g substantially aligned, subparts 210c and 50c have subparts 220a, 230a, and 52a substantially aligned, and subparts 210zz and 50zz have subparts 220f, 230f, and 52f substantially aligned. First directions 85 and 87 and second directions 86 and 89 are rotated slightly relative to each other, respectively.

Given an inkjet printhead built with a composite array device (275) as shown in FIGS. 13 and 14, we choose the orifice component (230a-i), bubble chamber component (220a-i), and resistor element component (52a-i) that are substantially aligned for each subparts (51a-zz, 210a-zz) and use them to print. Given a paper direction, or relative movement of the printhead to the paper in direction (85), we can delay each pixel in the print to compensate for the position of the best orifice/resistor.

Alternatively, it can be decided to print with more than one best alignment of orifice components (230a-i), bubble chamber components (220a-i), and resistor element components (52a-i), for each combined subpart (51a-zz, 210a-zz). One embodiment of doing this alternates between the two best orifice component/resistor component combinations writing every other line in the image (or every other pixel in a line, for example) with an alternate best orifice while electronically delaying the pixel information to compensate for the location of the orifice. We can also delay the pixel information to compensate for the direction of a drop through a resistor component/orifice component combination. In exemplary embodiments having small differences between pitches (42 and 72) along directions (85, 87), and small difference in pitches (235 and 237) along directions (86, 87) all orifices in the printhead can be used to print, using the misalignment between the resistor components (52a-i) and the orifice components (230a-i) to provide a somewhat randomized placement of each drop, so that image noise is disguised.

For all of the exemplary embodiments identified, each orifice can be checked for operation by monitoring the shadow of a drop as it is ejected through each orifice, or detecting the presence of a line on paper created by each orifice, to eliminate using orifices/resistor combinations that are deemed to be inoperable. In such cases the next best nozzle can be chosen for each column (a-zz).

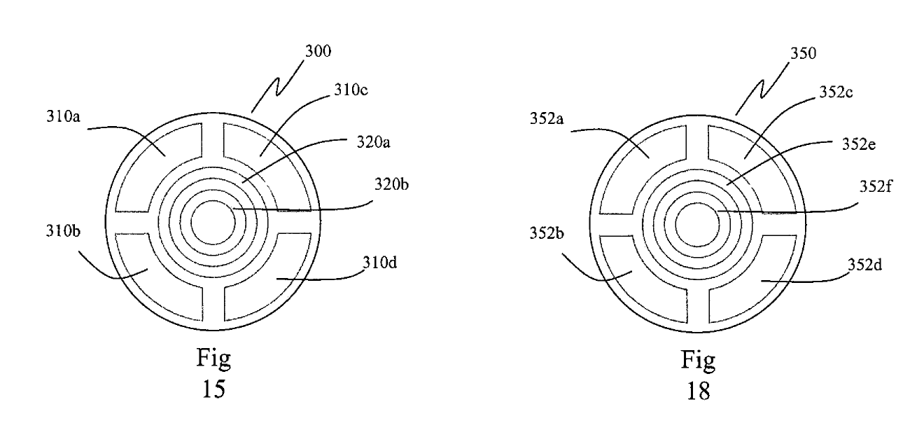

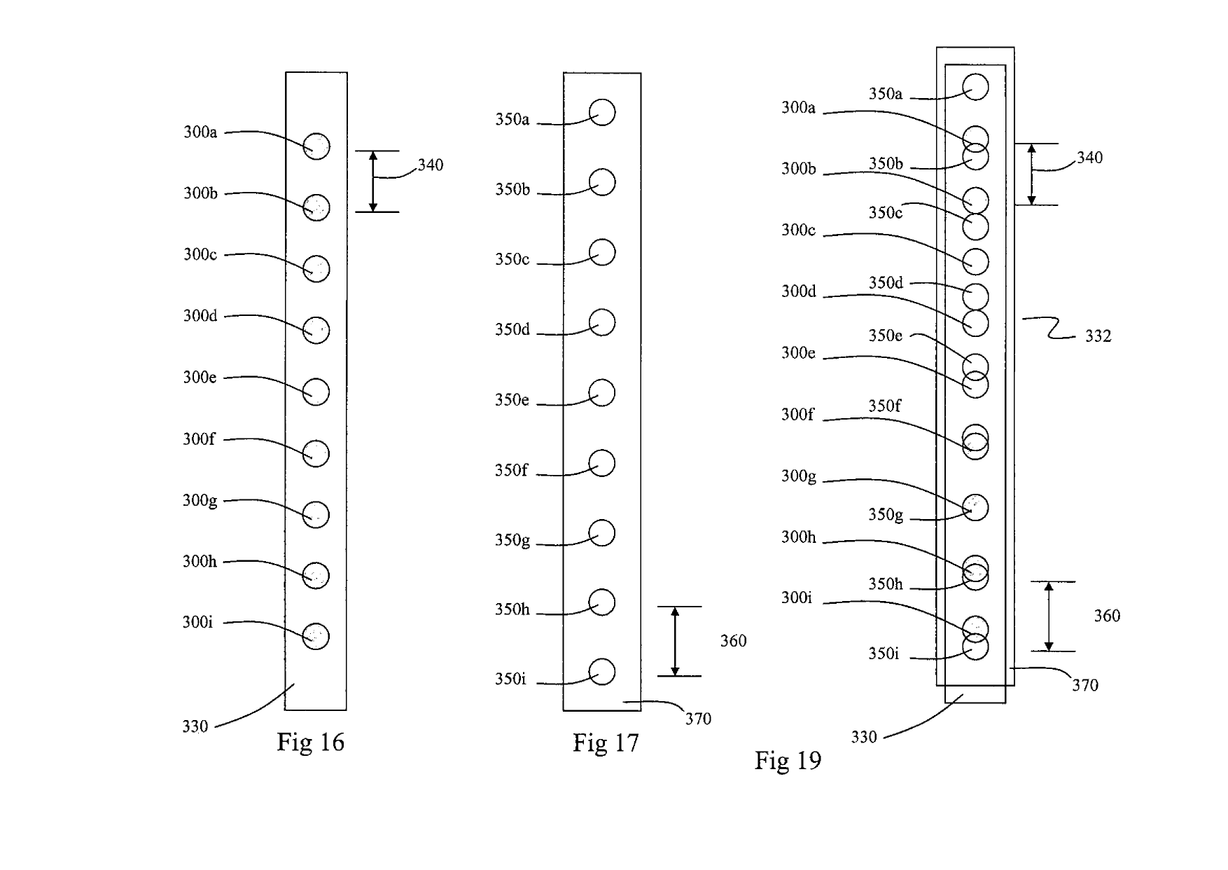

Embodiments described above relate to making thermal inkjet printheads, but embodiments of the present invention can also be used for making optical devices or electronic devices as well. FIG. 15 shows a surface emitting laser diode component (300) as disclosed by Kwon, U.S. Pat. No. 5,561,683, having grating components (320a, 320b), and electrode components (310a-d). Such a surface emitting laser diode component (300) with features that include grating components (320a-b) can be aligned in an embodiment of the present invention. A first part (330) is composed of multiple surface emitting laser diode components (300a-i) with a first pitch (340) as shown in FIG. 16. FIG. 17 shows a second part (370) composed of lens components (350a-i) arranged at a second pitch (360) different then the first pitch (340). FIG. 18 shows each lens component (350) having of a surface feature components (352a-f), as disclosed by Kwon, U.S. Pat. No. 5,561,683, which are designed to align to surface emitting laser diode (300) grating feature components (320a, 320b). FIG. 19 shows a composite device (332) including of a second part (370) of second lens components (350a-i) fastened to a first part (330) of first component lasers (300a-i), resulting in lens component (350g) having most preferable alignment with laser component (300g). The subset of substantially aligned composite components includes lens component 350g aligned to laser component 300g. The number of substantially aligned composite components can be increased by decreasing the differences between the first pitch and second pitch. The number of elements in each set of components can also be increased.

A most preferred aligned lens to a surface emitting laser diode or other emitting device can be chosen to increase optical output, reduce spherical aberrations, reduce coma, or reduce astigmatism.

This invention can also be applied to other optical composite devices, for example, including light sources, gratings, lenses, and photodetectors.

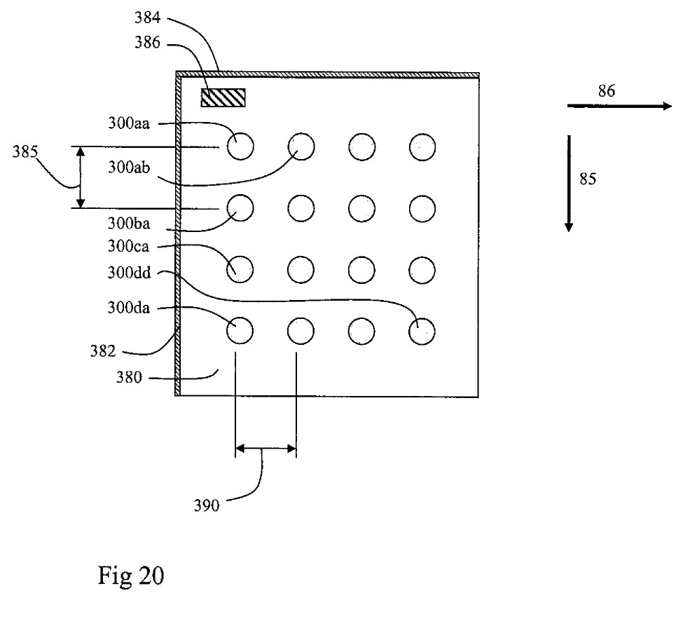

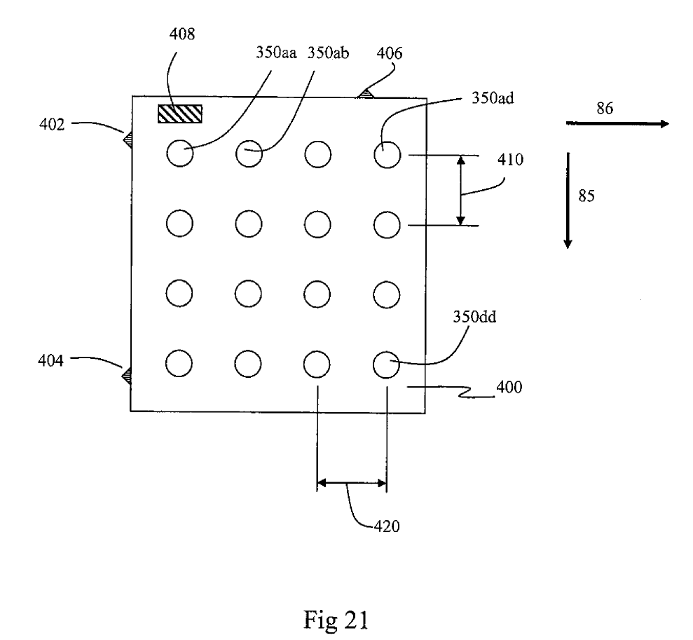

FIG. 20 shows a first part (380) including first components (300aa-dd) where each component 300 is a surface emitting laser diode at a first pitch (385) in a first direction (85) and a third pitch (390) in a second direction (86). Said first part (380) has optional alignment mechanisms composed of raised surfaces (382, 384). Said first part (380) can also include alignment marks (386). FIG. 21 shows a second part (400) composed of second components (350aa-dd) where each component (350) is a lens at a second pitch (410) in the first direction (85) different from the first pitch (385) and a fourth pitch (420) in the second direction (86) different from the third pitch (390). The second part (400) can also include locating mechanisms such as point contacts (402, 404, 406). The second array (400) can also include alignment marks (408).

One skilled in the art will recognize that a locating mechanism contained in first part (380) and second part (400) can include flats, walls, surfaces, point contacts, v-grooves, ball contacts, keys, keyways, slots, micro mechanical features, SU-8 epoxy pads or built up bumps, deep reactive ion etched silicon features, or any other means to constrain or locate one device to another.

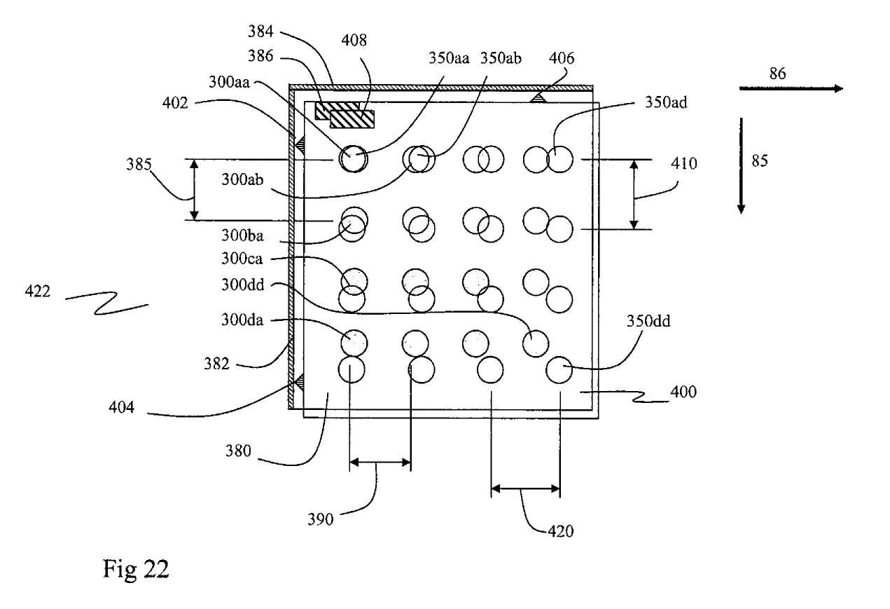

FIG. 22 shows a composite device (422) having of the first part (380) affixed to the second part (400) with the first components (300aa-dd) aligned to the second components (350aa-dd) where an alignment between first and second components is shown at location aa. The subset of substantially aligned composite components includes composite component aa composed of components 300aa and 350aa. In FIG. 22 alignment of the two arrays is controlled by the size of point contact features (402, 404, 406) and location of surfaces (382, 384). In a molding process the size of point contact features relative to the placement of device features is difficult to hold. The present invention results in at least one of the aligned first and second components being aligned to within an acceptable tolerance.

The first and second parts can be held or fastened together by abutting the second locating mechanism to the first alignment mechanism. The first and second parts can be free to differentially expand as they heat up due to ambient temperature changes or heat dissipation due to electrical operation or friction.

A subset of aligned components can be chosen for use. The subset of best aligned components can be adjusted as the first and second parts differentially heat up and the parts move or expand at different rates due to ambient temperature changes or part temperature changes.

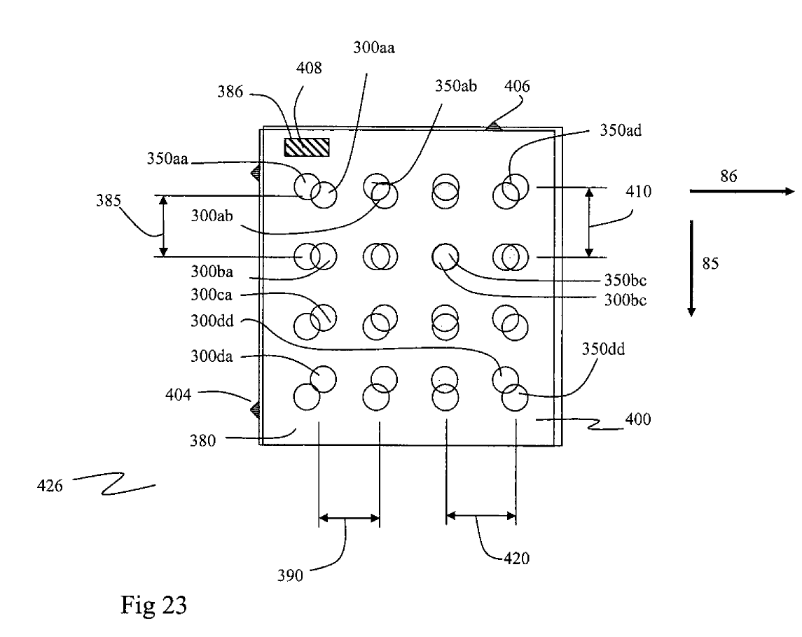

FIG. 23 shows a first part (380) with alignment marks (386) and a second part (400) with alignment marks (408) such that the alignment marks are used to align the first and second part as they are affixed together. FIG. 23 demonstrates a subset of substantially aligned composite components that includes the aligned composite component having of the first part component (300bc) affixed to second part component (350bc). Optional alignment surfaces (382, 384) on first part 380 are not included in this example.

First part components (300aa-dd) affixed to second part components (350aa-dd) as shown in FIGS. 22 and 23 can be cut apart into individual composite devices (aa-dd) of different levels of alignment. A first subset of first components (300aa-dd) affixed to second components (350aa-dd) can be chosen to be used while the inverse subset can be ignored or disabled. The remaining surface emitting laser diode components (300) that are out of tolerance can be disabled by laser ablating their electrical connection components (310) shown in FIG. 15.

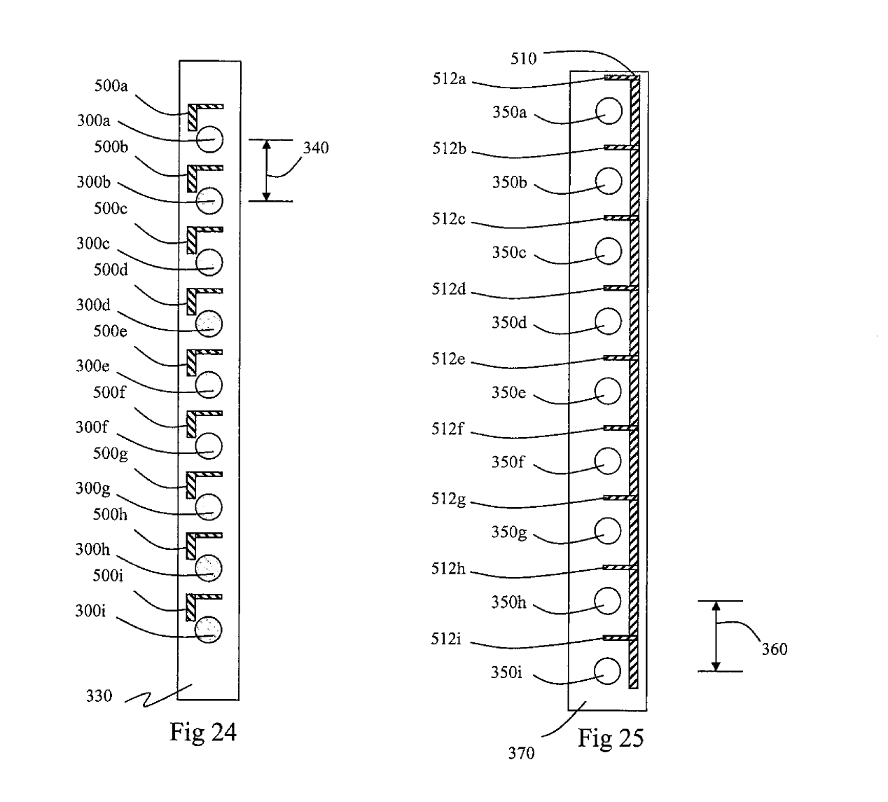

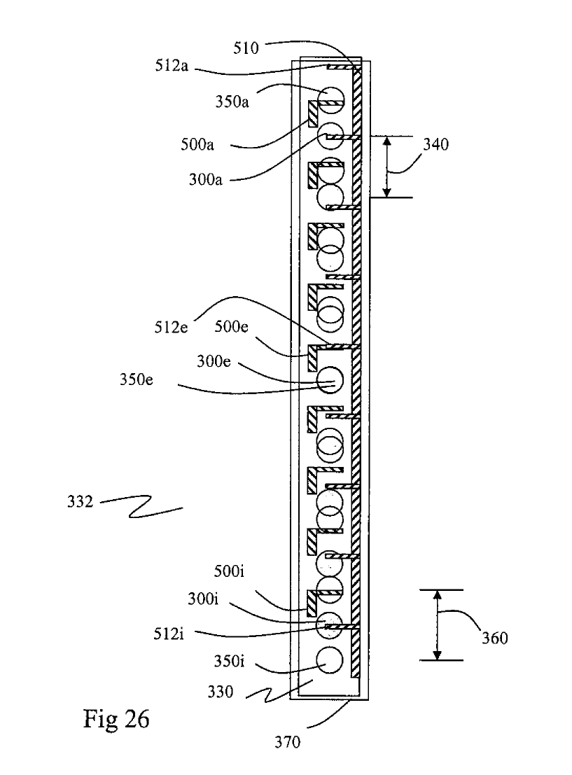

In another embodiment FIG. 24 shows a first part (330) including first components (300a-i) including of surface emitting laser diodes (300a-i) arranged at a pitch of (340). Each first surface emitting laser diode component (300a-i) has associated with it an electrical connection component (500a-i) also at the first pitch (340). FIG. 25 shows a second part (370) composed of lens components (350a-i) including lenses at a second pitch (360) along with a common electrical connection component (510) with individual finger components (512a-i) at said second pitch (360). Said second pitch (360) is different from said first pitch (340). FIG. 26 shows a composite device (332) composed of the first part (330) affixed to the second part (370) such that a subset of first surface emitting laser diode components (300a-i) aligns with second lens components (350a-i) in conjunction with an electrical connection component (500a-i) for first surface emitting laser diodes aligning to electrical connection component (510) with fingers (512a-i) so that the alignment between first and second parts (laser diode 300e and lens 350e) also includes an electrical connection (500e, 512e).

The electrical connection can be enhanced by solder, contact, pressure, conductive epoxy, or by applying heat and pressure to bond the two electrical conductors together.

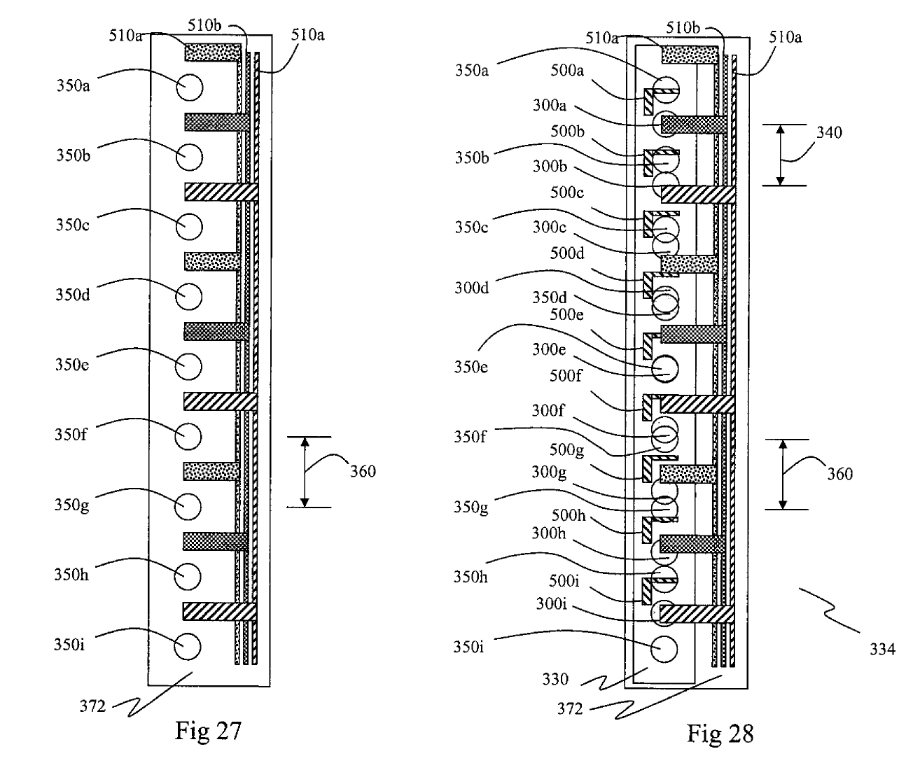

In yet another embodiment, FIG. 24 shows a first part (330) of first components (300a-i) with surface emitting laser diodes (300a-i) arranged at a pitch of (340). Each first surface emitting laser diode component (300a-i) has associated with it an electrical connection (500a-i) also at the first pitch (340). FIG. 27 shows a second part (372) composed of second lens components (350a-i) with lenses at a second pitch (360) along with an electrical connection component (510a-c) with fingers at multiples of said second pitch (360). Said second pitch (360) is different from said first pitch (340). Electrical connection components (510a-c) are designed such that three adjacent connections are on separate circuits allowing them to be individually controlled with a minimum of three transistors (not shown). One skilled in the art will recognize that the invention can be used to multiplex components depending upon the magnitude of the pitches and the number of components per part. When the parts are combined as composite device (334) in FIG. 28 then the most preferable composite component is on its own circuit, and there are adjacent circuits that are available, separate from each other and from the most preferable composite component. One skilled in the art will recognize that two or more circuits can be made. One skilled in the art will recognize that instead of an electrical circuit, a fluidic circuit, or mechanical connection, can be made using the present invention. FIG. 28 shows a composite device (334) composed of a first part (330) affixed to a second part (372) such that a subset of first surface emitting laser diode components (300a-i) align with second lens components (350a-i) in conjunction with an electrical connection component (500a-i) aligning to electrical connection component (510a-c) with fingers, so that a preferable alignment between first and second parts also includes an electrical connection. The alignment between first and second parts adjacent to the preferable alignment also includes a unique connection. In FIG. 28 the subset of substantially aligned composite components includes composite components d, e, and f. Composite components d and f are aligned to a first tolerance. Composite component e is aligned to a second tolerance where the second tolerance is tighter than the first tolerance.

One skilled in the art will recognize that FIG. 24 has a set of electrical connection components (500a-i) that are individual electrodes. FIG. 25 has an electrical connection component (510) that is a common electrode having a feature for each component within the set at a pitch. The present invention includes individual components at a pitch and common components with individual features at a pitch. In addition FIG. 27 shows an electrical conductor component (510a-c) that is semi-common having features at a pitch that connect to more than one component in the set. One skilled in the art will recognize that individual, common, and semi-common, components can be electrical connections, fluidic paths, fluidic connections, optical wave guides, doped silicon areas, non-conducting components, or other components with a feature or individually at a pitch.

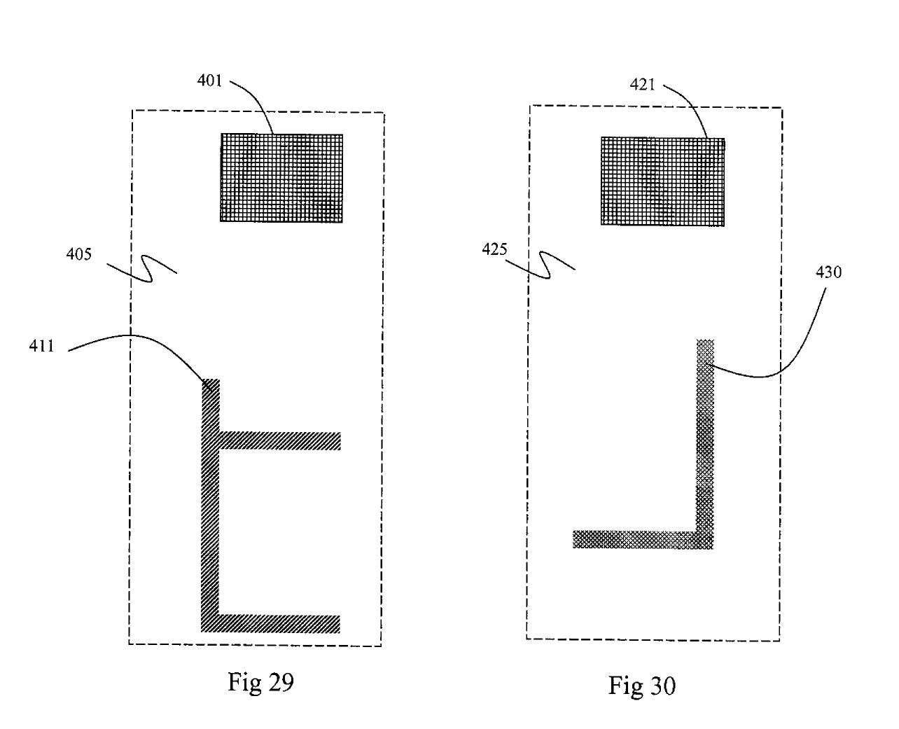

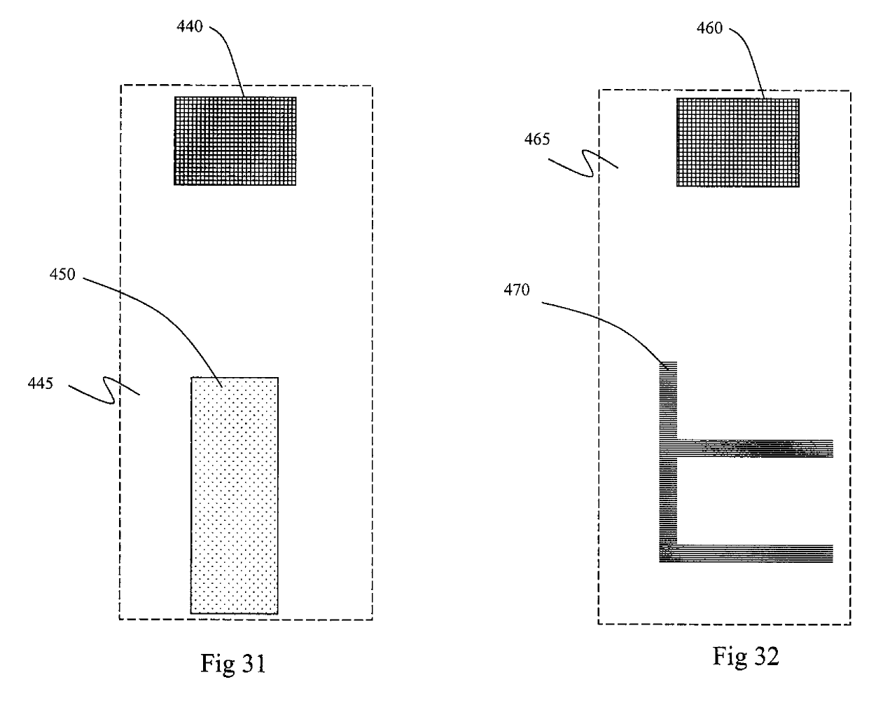

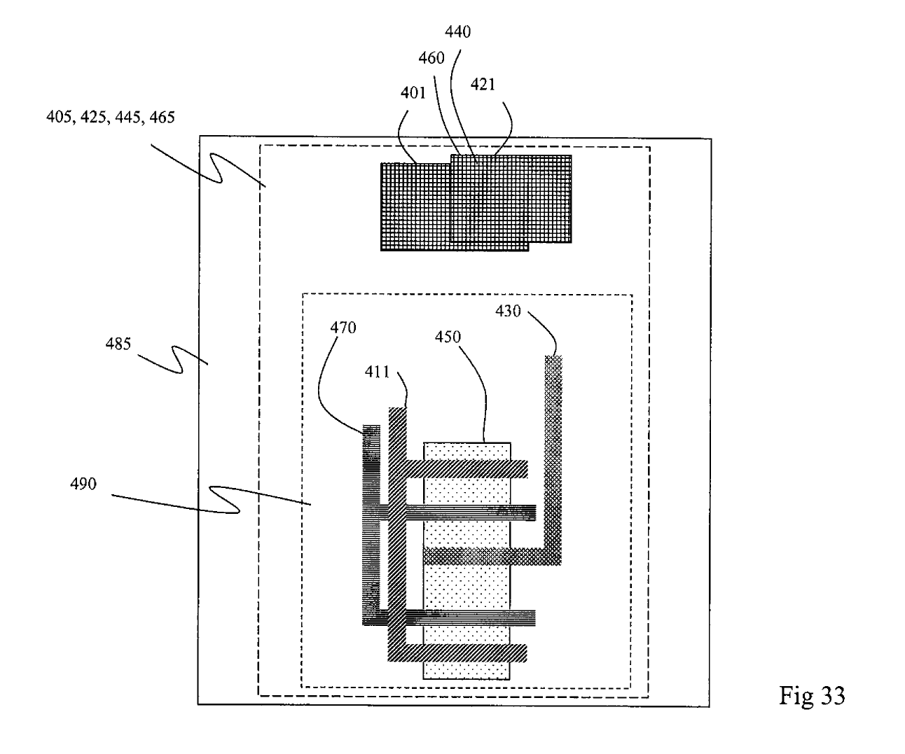

The present invention anticipates that the composite device can be composed of parts that are features created using two lithographic masks or two sets of lithographic masks. In such embodiments, the parts are combined together by lithographically forming them on one substrate. FIG. 29 is a mask (405) with a feature defining a source electrode component (411) to a transistor component. The mask (405) also contains a registration mark (401). FIG. 30 is a mask (425) with a feature defining a drain electrode component (430) to a transistor component. The mask (425) also contains a registration mark (421). FIG. 31 is a mask (445) containing a doped area component (450) of a transistor with an alignment mark (440). FIG. 32 is a mask (465) containing a gate electrode component (470) and an alignment mark (460). FIG. 33 is a transistor composite device (490) on a substrate (485) composed of part components (470, 411, 450, and 430). For a transistor of this type it is important to control the distance of the gate electrode component (470) to the drain electrode component (430) and or the source electrode component (411). Typically the drain electrode component (430) and the source electrode component (411) can be defined by the same mask in one step. Variability between transistors in a large device causes a different electrical gain transistor to transistor. The present invention can be used by assigning the steps to make the source electrode component (411) and drain electrode component (430) as the components of the first part arranged at a first pitch, and then assigning the steps to make the gate electrode component (470) as the components of the second part arranged at a second pitch.

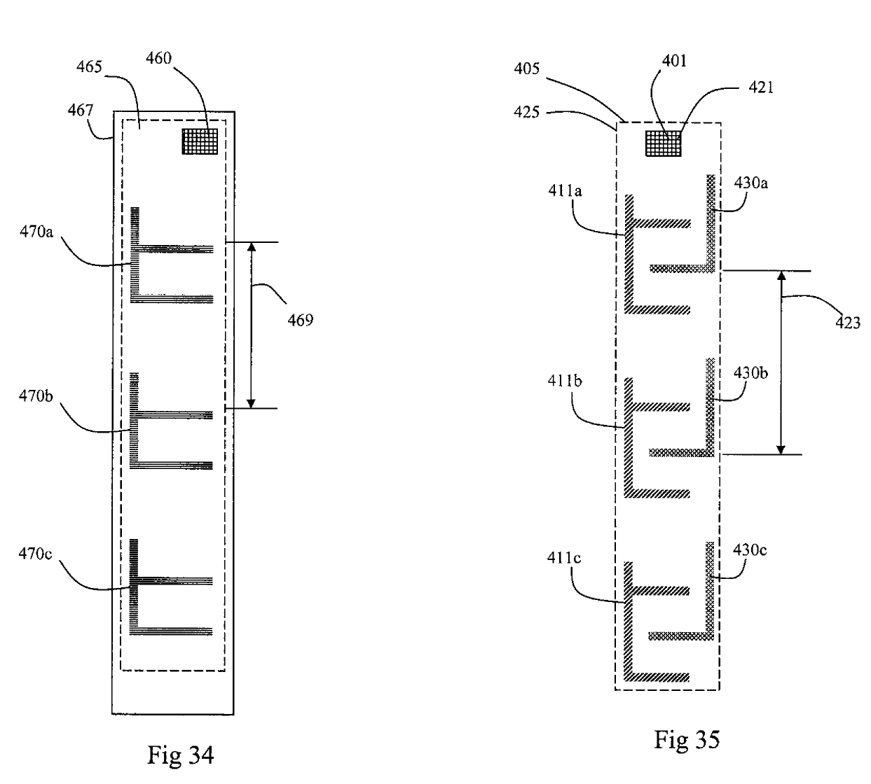

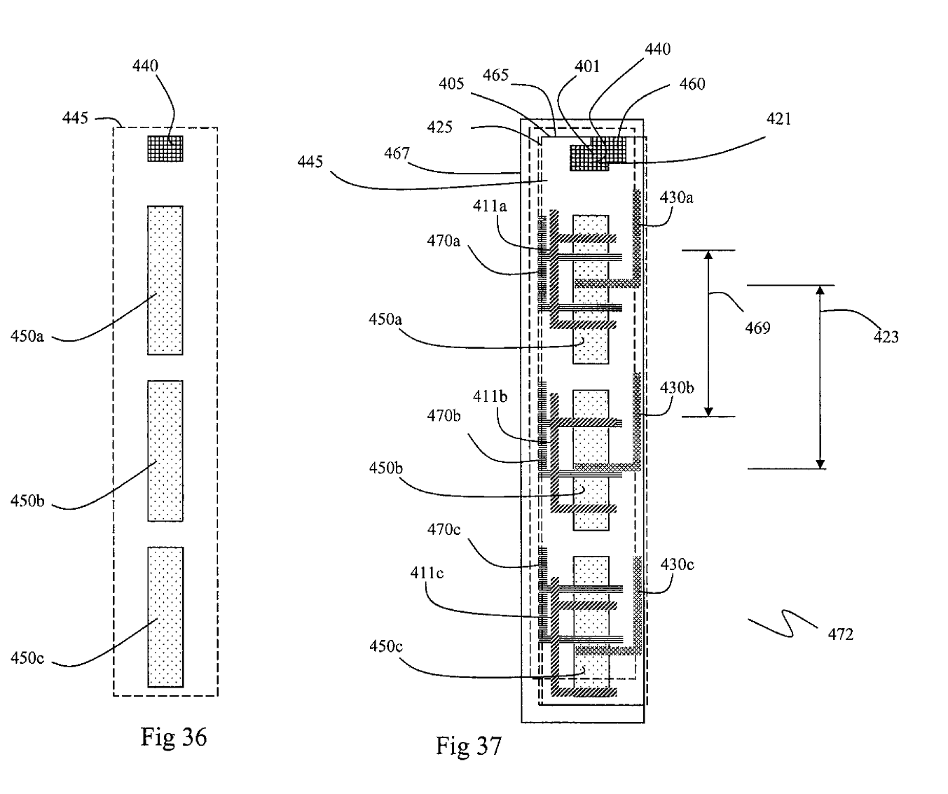

FIG. 34 illustrates a first part mask (465) composed on a substrate (467) including of an alignment mark (460) with transistor gate electrode components (470a-c) arranged at a first pitch (469). FIG. 35 illustrates the second part masks (405, 425) to be added to substrate (467) in subsequent steps. Second part masks (405, 425) have registration marks (401, 421), transistor source electrode components (411a-c) and transistor drain electrode components (430a-c); wherein the transistor source components and transistor drain components are at a second pitch (423), different from said first pitch (469). FIG. 36 illustrates a third part mask (445) to be added to substrate (467) in a subsequent step. This third part mask (445) includes a registration mark (440) and transistor doped area components (450a-c). FIG. 37 is an embodiment of the present invention showing a composite device (472) having a substrate (467) having first transistor gate electrode components (470a-c) at a first pitch (469) combined with second transistor source and drain electrode components (411a-c, 430a-c) at a second pitch (423) with third transistor doped area components (450a-c). The registration alignment marks (401, 421 440, and 460) are registration alignment marks created from lithographic operations. The alignment marks are used to align masks and perform photolithography on a composite device that is composed of a part including a set of first components at a first pitch and a set of second components at a second pitch. The combination or subset of the combination of components is selected that are best aligned. In the example embodiment shown in FIG. 37, large arrays of identical transistors can be made by choosing the indicated transistor, using source, drain, and gate (a) components. The unwanted transistors can be disabled by laser ablation of their source, drain, and or gate lines. One skilled in the art can recognize that we can combine conductive electrode features with the transistor source, drain, and gate features to use the present invention to automatically electronically connect a desired transistor.

One skilled in the art will recognize that the present invention can be used to make large arrays of transistors, substantially the same, for use in driving one or two dimensional arrays of organic light emitting diodes (OLEDs), light emitting diodes, or laser diodes, where the light output is dependent upon the current. In this embodiment of the invention the transistor is selected to deliver uniform current, thereby, achieving uniform light output.

A most preferred aligned electronic component composite device can be chosen to increase current or voltage gain, reduce resistance, improve uniformity, achieve a target resistance or gain, improve reliability, increase life expectancy, provide a target output wavelength, or achieve a target spacing or overlap.

One skilled in the art will recognize that the present invention can be used in electronic composite devices, including components, such as doped semiconductor regions, conducting regions, conductors, insulators, resistors, band-gap materials, index-matching regions, reflective coatings, reflective surfaces and layers, and non-conducting regions. One skilled in the art will recognize that the present invention can be used with components having resonating cavity components used in a laser diode, or light emitting surfaces, or surface features creating lenses or coupling optical energy out of the device.

An embodiment of the invention is a composite device including a component having a microfluidic chamber. The composite device could have a microfluidic chamber combined with one of the aforementioned electronic or optical components described above.

One skilled in the art will recognize that the difference between the first and second pitch shown in the drawings of these embodiments can be smaller than that shown. In the drawings, the difference between pitches was made purposely large in order to clearly show the invention. Given a part manufacturing tolerance with a standard deviation of variability, then let a equal the higher standard deviation of variability between the first and second parts, one would expect all parts to fall within ±6σ. Let P be the first pitch and P+ΔP be the second pitch. Ideally we would set the change in pitch (ΔP), the width of the components (W), and the number of components (N) per single part such that a part within 6 σ tolerance (±3 σ) would guarantee that greater than 99% of the time the combined part will have a working device by setting N=6 σ/ΔP, where ΔP is the tolerance required for a working combined device. Note for a normal distribution 99.73% of the data falls within ±3σ range giving us a range of 6σ. Alternatively, there is almost 100% probability that all parts will fall within ±6 σ tolerance, so setting N≧12 σ/ΔP will guarantee 100% yield for all practical purposes. It is an advantage of the present invention that one can achieve 100% composite device yields using two parts that individually have less than ±6 σ tolerances.

An embodiment of the invention includes a difference between the first and second pitch, a manufacturing tolerance for the first and second parts, and choosing the number of components within the first set of components and the second set of components, so that the subset of substantially aligned composite components includes one or more composite components that are aligned to a predetermined tolerance.

An embodiment of the invention includes a difference between the first and second pitch, a manufacturing tolerance for the first and second parts, and choosing the number of components within the first set of components and the second set of components, so that the subset of substantially aligned composite components includes more than one composite components that are aligned to a predetermined tolerance.

Another embodiment of the invention includes a difference between the first and second pitch, a manufacturing tolerance for the first and second parts, and choosing the number of components within the first set of components and the second set of components so that the subset of substantially aligned composite components includes more than one composite components that are aligned to a predetermined first tolerance and one composite component within the subset of substantially aligned composite components is aligned to a second tighter tolerance.

Another embodiment of the invention includes a difference between the first and second pitch, a manufacturing tolerance for the first part, and a manufacturing tolerance for the second part, and choosing the number of components within the first set of components and the second set of components so that all of the composite components are aligned to a predetermined first tolerance and at least one composite component within the subset of substantially aligned composite components is aligned to a second tighter tolerance and the subset of substantially aligned composite components includes all composite components.

The invention has been described in detail with particular reference to certain preferred embodiments thereof, but it will be understood that variations and modifications can be effected within the spirit and scope of the invention.

### Parts List

10 first part
15 subpart
20 bubble chamber components (a-i)
30 orifice components (a-i)
40 first pitch
42 first pitch
45 multiple
50 second part
51 second subpart
52 resistor element components (a-i)
55 conductor
60 resistor
65 conductor
67 composite device
70 second pitch
72 second pitch
80 first direction
82 paper direction
84 second direction
85 first direction
86 second direction
87 first direction
89 second direction
100 first part
110 second part
120 composite array device
210 first subpart
212 composite device
214 composite device
220 first component (a-i)
230 first component (a-i)
235 third pitch
237 fourth pitch
275 first part
280 composite array device
300 surface emitting laser diode component
320 grating components
310 electrode components
330 first part
332 composite device
334 composite device
340 first pitch
350 lens components
352 surface feature components
360 second pitch
370 second part
372 second part
380 first part
382 raised surface
384 raised surface
385 first pitch
386 alignment mark
390 third pitch
400 second part
401 registration mark
402 point contact
404 point contact
405 mask
406 point contact
408 alignment mark
410 second pitch
411 source electrode component
420 fourth pitch
421 registration mark
422 composite device
423 second pitch
425 mask
430 drain electrode component
440 alignment mark
445 mask
450 doped area component
460 alignment mark
465 mask
467 substrate
469 first pitch
470 gate electrode component
472 composite device
485 substrate
490 transistor composite device
500 electrical connection component
510 electrical connection component
512 individual finger components

1. A method of making a composite device, comprising;
providing a first part including a first set of components at a first pitch;
providing a second part including a second set of components at a second pitch, different from the first pitch; and
fastening the first part to the second part to make a composite device, wherein the composite device includes a subset of the first set of components that are substantially aligned to a subset of the second set of components to form a corresponding subset of substantially aligned composite components.

2. The method of claim 1, further comprising the step of:
choosing a subset of substantially aligned composite components for operation in the composite device.

3. The method claimed in claim 1, wherein the corresponding subset of substantially aligned composite components includes more than one composite component.

4. The method claimed in claim 1, wherein the corresponding subset of substantially aligned composite components are within a predetermined tolerance.

5. The method claimed in claim 4, wherein the predetermined tolerance is a first predetermined tolerance and the corresponding subset of composite components includes one composite component aligned within a second predetermined tolerance, wherein the second predetermined tolerance is tighter than the first predetermined tolerance.

6. The method of claim 1, wherein the first pitch is P, the second pitch is P+ΔP, N is the number of components in the first part, σ is the larger of the two standard deviations of variability between the first and second parts, wherein ΔP is set to the tolerance required for a working composite component and N is greater than or equal to 6σ/ΔP.

7. The method of claim 1, the first pitch and the second pitch being in a first direction, wherein the first set of components in the first part have a third pitch in a second direction, and the second set of components in the second part have a fourth pitch in the second direction, wherein the fourth pitch is not equal to the third pitch.

8. The method of claim 1 wherein the component includes one or more of an inkjet orifice, an inkjet chamber, a drop forming mechanism, a laser diode, a light emitting diode, a lens, a conductive trace, a semiconductor, an insulator, a resistor, a grating, an optical cavity, a light source, a band-gap material, an index-matching layer, a reflective coating, a reflective surface or layer, a photodetector, a microfluidic chamber, a transistor gate, a transistor drain, and a transistor source.

9. The method of claim 1 wherein the two parts are fastened together using one of glue, epoxy, solder, welding, mechanical fasteners, snap fit, thermal bond, or tape.

10. The method of claim 1 wherein the two parts are formed together on one substrate.

11. The method of claim 10 wherein the two parts are formed together using photolithographic processes.

12. The method of claim 1 wherein the either the first or second part or both contain a registration mark or an alignment feature.

13. The method of claim 1 wherein the step of fastening allows each part to expand or contract relative to the other part.

14. The method of claim 13 wherein the subset of substantially aligned composite components changes as the first or second part expands or contracts over time.

15. The method of claim 1 wherein the subset of substantially aligned composite components changes over time.

16. A method of making a composite array device, comprising:
providing a first part including an array of first subparts where each subpart includes a first set of components at a first pitch;
providing a second part including an array of second subparts where each subpart includes a second set of components at a second pitch, different from the first pitch; and
fastening the first part to the second part to make a composite array device, wherein the composite array device includes an array of subsets of the first set of components that are substantially aligned to an array of subsets of the second set of components to form a corresponding array of subsets of substantially aligned composite components.

17. The method of claim 16 wherein the composite array device is an inkjet printhead;
the first set of components includes an orifice; and
the second set of components includes a drop forming mechanism.

18. The method claimed in claim 16, wherein the corresponding array of subsets of substantially aligned composite components includes more than one substantially aligned composite component.

19. The method claimed in claim 16, wherein each subset of the corresponding array of subsets of substantially aligned composite components includes at least one substantially aligned composite component within a predetermined tolerance.

20. The method claimed in claim 19, wherein the predetermined tolerance is a first predetermined tolerance and, for each subset in the array of subsets, a corresponding subset of substantially aligned composite components includes one substantially aligned composite component aligned within a second predetermined tolerance, wherein the second predetermined tolerance is tighter than the first predetermined tolerance.
